(19) United States
(12) Patent Application Publication
(10) Pub. No.: US 2022/0035122 A1
(43) Pub. Date: Feb. 3, 2022

(54) Actuator Arrangement for Camera Size Reduction

(71) Applicant: Apple Inc., Cupertino, CA (US)

(72) Inventor: Zachary W. Birnbaum, Saratoga, CA (US)

(73) Assignee: Apple Inc., Cupertino, CA (US)

(21) Appl. No.: 17/391,892

(22) Filed: Aug. 2, 2021

Related U.S. Application Data
(60) Provisional application No. 63/060,613, filed on Aug. 3, 2020.

(51) Int. Cl. G02B 7/09; G02B 27/64; G03B 13/36; G03B 5/00; G02B 7/02

(52) U.S. Cl. CPC G02B 7/09; G02B 27/646; G03B 2205/0007; G03B 5/00; G02B 7/021; G03B 13/36

(57) ABSTRACT

Various embodiments include a camera having an actuator arrangement that may enable a camera size reduction. For example, the camera may include a voice coil motor (VCM) actuator to move a lens group relative to an image sensor. According to some embodiments, the VCM actuator may include one or more magnets and one or more coils positioned near an underside of a flange defined by a lens barrel arrangement. In some embodiments, the camera may include a suspension arrangement comprising one or more springs for suspending a lens barrel arrangement from one or more stationary structures of the camera. The magnet(s) and the coil(s) of the actuator arrangement may be positioned above the spring(s) of the suspension arrangement in some embodiments.

This application claims benefit of priority to U.S. Provisional Application Ser. No. 63/060,613, entitled “Actuator Arrangement for Camera Size Reduction,” filed Aug. 3, 2020, and which is incorporated herein by reference in its entirety.

### BACKGROUND

### Technical Field

This disclosure relates generally to architecture for a camera, including an actuator arrangement that may enable a camera size reduction.

### Description of the Related Art

The advent of small, mobile multipurpose devices such as smartphones and tablet or pad devices has resulted in a need for high-resolution, small form factor cameras for integration in the devices. Some small form factor cameras may incorporate optical image stabilization (OIS) mechanisms that may sense and react to external excitation/disturbance by adjusting location of the optical lens on the X and/or Y axis in an attempt to compensate for unwanted motion of the lens. Some small form factor cameras may incorporate an autofocus (AF) mechanism whereby the object focal distance can be adjusted to focus an object plane in front of the camera at an image plane to be captured by the image sensor. In some such autofocus mechanisms, the optical lens is moved as a single rigid body along the optical axis of the camera to refocus the camera.

### BRIEF DESCRIPTION OF THE DRAWINGS

FIG. 1 illustrates a perspective view and a side cross-sectional view of an example camera having an actuator arrangement that may enable a camera size reduction (e.g., as compared to some other cameras having a different actuator arrangement), in accordance with some embodiments.

FIGS. 2A-2C illustrate views of an example camera having an actuator arrangement that may enable a camera size reduction, in accordance with some embodiments. FIG. 2A shows a top view of the camera. FIG. 2B shows a side cross-sectional view of the camera. FIG. 2C shows a perspective cross-sectional view of the camera.

FIGS. 3A-3G each illustrates a respective schematic diagram of a respective example magnetic arrangement comprising bar magnets, for an actuator arrangement that may enable a camera size reduction, in accordance with some embodiments.

FIGS. 4A-4H each illustrates a respective schematic diagram of a respective example magnetic arrangement comprising one or more arced magnets, for an actuator arrangement that may enable a camera size reduction, in accordance with some embodiments.

FIGS. 5A-5B each illustrates a respective schematic side view of a respective example system that includes a camera (having an actuator arrangement that may enable a camera size reduction) mounted in a device, in accordance with some embodiments.

FIG. 6 illustrates a schematic representation of an example device that may include a camera having an actuator arrangement that may enable a camera size reduction, in accordance with some embodiments.

FIG. 7 illustrates a schematic block diagram of an example computer system that may include a camera having an actuator arrangement that may enable a camera size reduction, in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f) for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### DETAILED DESCRIPTION

Some embodiments include a camera having an actuator arrangement that may enable a camera size reduction. For example, the camera may include a voice coil motor (VCM) actuator to move a lens group relative to an image sensor. In some embodiments, the VCM actuator may include one or more magnets and one or more coils positioned near an underside of a flange defined by a lens barrel arrangement. The lens barrel arrangement may include a lens barrel for holding one or more lens elements. Additionally, or alternatively, the lens barrel arrangement may include a lens carrier that is fixedly coupled with the lens barrel. According to some embodiments, the magnet(s) and the coil(s) may electromagnetically interact with each other to move the lens group in a direction parallel to an optical axis (e.g., a Z-axis direction) of the camera, e.g., to provide AF functionality.

The actuator arrangements described herein enable a reduced camera size compared to some other cameras with different actuator arrangements. In some embodiments, a reduced camera size in one or more directions orthogonal to the optical axis (e.g., an X dimension and/or a Y dimension of the camera) may be achieved by exploiting an otherwise unutilized empty space. As a non-limiting example, as mentioned above, the magnet(s) and the coil(s) of the actuator arrangements described herein may be contained within a cavity at least partially defined by the underside of the flange and an outer surface of a lens barrel arrangement. In some embodiments, the cavity may be defined by a periphery of the flange and the outer surface of the lens barrel arrangement. By contrast, other cameras with different actuator arrangements may not utilize such a cavity underneath a flange. In some embodiments, the magnet(s) and the coil(s) of the actuator arrangements described herein may be positioned above the springs of a suspension arrangement used for suspending the lens barrel arrangement (and the lens group) from one or more stationary structures of the camera, whereas other cameras with different actuator arrangements may comprise a suspension arrangement that includes one or more springs above the magnet(s) and/or coil(s).

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

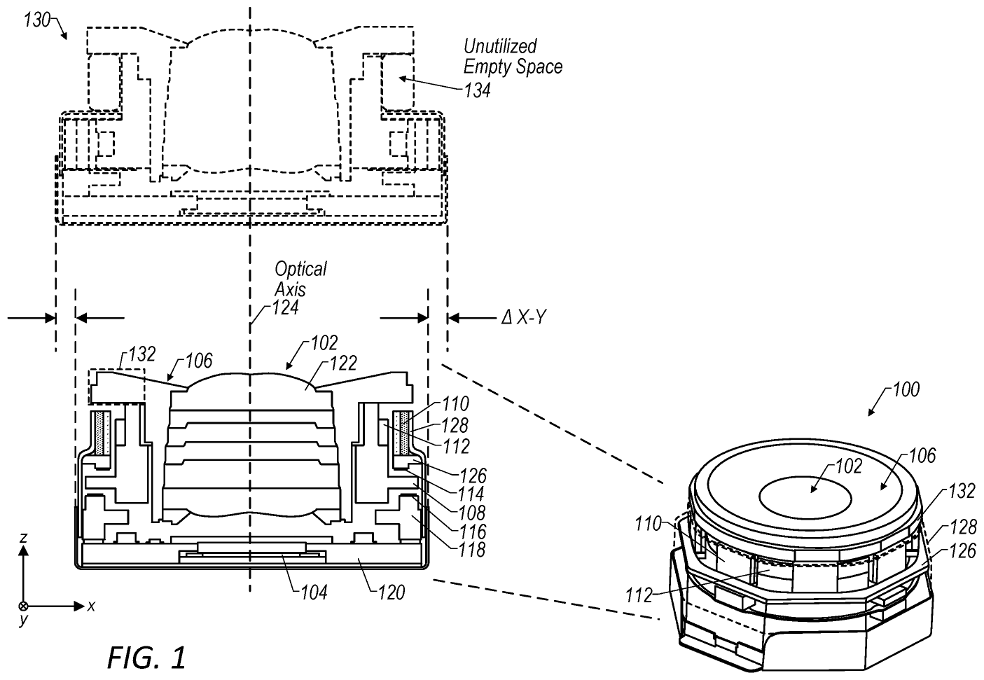

FIG. 1 illustrates a perspective view and a side cross-sectional view of an example camera 100 having an actuator arrangement that may enable a camera size reduction, e.g., as compared to some other cameras having a different actuator arrangement. The example X-Y-Z coordinate system shown in FIG. 1 may apply to embodiments discussed throughout this disclosure.

In some embodiments, the camera 100 may include a lens group 102, an image sensor 104, a lens barrel 106, a lens carrier 108, an actuator (e.g., comprising one or more magnets 110 and one or more coils 112), a suspension arrangement (e.g., comprising an upper spring 114 and/or a lower spring 116), a base structure 118, and/or a substrate 120. The lens group 102 may include one or more lens elements 122 that define an optical axis 124. The image sensor 104 may be configured to capture image data based on light that passes through the lens group 102. In some embodiments, the image sensor 104 may be attached to the substrate 120. In some embodiments, the lens group 102 may be coupled with the lens carrier 108. According to some embodiments, the lens group 102 may be contained within the lens barrel 106, and the lens barrel 106 may be fixedly attached to the lens carrier 108 such that the lens group 102 is movable together (e.g., in lockstep) with the lens carrier 108, e.g., via the actuator. In various embodiments, the lens barrel 106 and/or the lens carrier 108 may form a lens barrel arrangement. While the lens barrel 106 and the lens carrier 108 may be components that are individually formed and subsequently coupled to form the lens barrel arrangement, the lens barrel arrangement may be integrally formed (e.g., formed as a single component) in some embodiments. Furthermore, it should be appreciated that structural and/or functional aspects of the lens barrel 106 may additionally or alternatively be present in the lens carrier 108, and vice-versa.

According to various embodiments, the actuator may be configured to move the lens group 102 relative to the image sensor 104. In some embodiments, the actuator may move the lens group 102 in a direction parallel to the optical axis 124 (e.g., the Z-axis direction), e.g., to provide focus and/or autofocus (AF) functionality. FIG. 1 shows the actuator suitably configured for providing AF functionality. However, the actuator (and/or one or more other actuators of the camera 100) may additionally, or alternatively, be configured to move the lens group 102 in one or more directions orthogonal to the optical axis 124 (e.g., the X-axis direction and/or the Y-axis direction), e.g., to provide optical image stabilization (OIS) functionality.

In various embodiments, the actuator may comprise a voice coil motor (VCM) actuator. For example, the actuator may include one or more magnets that electromagnetically interact with one or more coils (e.g., when current is supplied to the coil(s)) to produce Lorentz forces that move the lens group 102 relative to the image sensor 104. For example, in FIG. 1, the magnet(s) 110 and coil(s) 112 may be arranged such that they produce Lorentz forces that move the lens group 102 in a direction parallel to the optical axis 124 to provide AF. It should be appreciated, however, that the magnet(s) 110 and coil(s) 112 may be arranged such that they produce Lorentz forces that move the lens group 102 laterally (e.g., in directions orthogonal to the optical axis 124) to provide OIS in some embodiments. Certain modifications to the AF arrangement shown in FIG. 1, e.g., modifications to clearances between camera components, suspension spring connections, etc., may be made to account for the different direction(s) of movement associated with OIS.

In some embodiments, the actuator may include one or more magnets 110 and one or more coils 112. According to various embodiments, the magnet(s) 110 may be coupled with one or more stationary structures of the camera 100. For example, such stationary structure(s) may include one or more mounting spacers 126 and/or a shield can 128. Furthermore, the coil(s) 112 may be coupled with the lens carrier 108 in various embodiments. In some examples, the magnet(s) 110 and the coil(s) 112 may be arranged so as to be in proximity with one another (e.g., in “magnet-coil group(s),” such as magnet-coil pair(s) and/or other magnet-coil grouping combination(s)) so as to be capable of electromagnetically interacting to produce Lorentz forces as discussed above.

As indicated in FIG. 1, the actuator may include magnet(s) 110 arranged circumferentially around the lens group 102, the lens barrel 106, and/or the lens carrier 108 in some embodiments. Furthermore, the actuator may include an coil 112 that at least partially encircles the lens carrier 108. For example, the coil 112 may be a ring-shaped coil that is wound around, and attached to, a portion the lens carrier 108. In some non-limiting embodiments, respective groupings of a respective magnet 110 and the coil 112 may be considered a respective magnet-coil group.

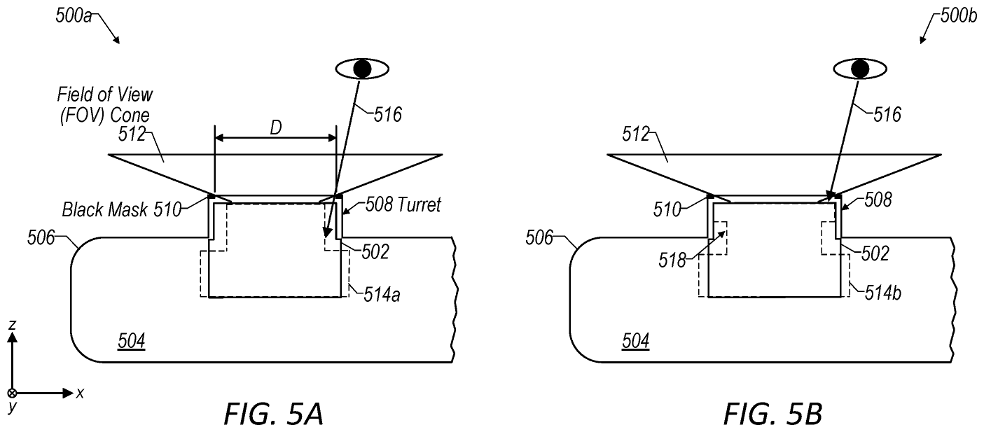

As previously mentioned, the camera 100 may have an actuator arrangement that enables a reduced camera size, e.g., as compared to some other cameras (e.g., camera 130) with different actuator arrangements. In some embodiments, a reduced camera size in the X dimension and/or the Y dimension (e.g., as indicated by A X-Y in comparison to the other camera 130) may be achieved by exploiting an otherwise unutilized empty space. According to some embodiments, the lens barrel 106 may have a flange 132 that extends in a direction orthogonal to the optical axis 124, e.g., as indicated in FIG. 1. For example, it may be desirable for the camera 100 to include the flange 132 to bridge a gap that might otherwise be present between the lens barrel 106 and a black mask applied to a cover window, e.g., as discussed herein with reference to FIG. 5A. Such a gap could allow a user to see internal components of a camera, which may be undesirable from an industrial design and/or cosmetic point of view. By contrast, the flange 132 can fill in such a gap to block the user's line of sight so that the user is unable to see the internal components of the camera 100. The magnet(s) 110 and the coil(s) 112 of the actuator may be contained within a cavity that is at least partially defined by an underside of the flange 132 and an outer surface of the lens carrier 108 in various embodiments. By contrast, the other camera 130 has a different actuator arrangement that does not utilize such a cavity underneath its flange, e.g., as indicated by unutilized empty space 134. In some embodiments, the actuator arrangement of camera 130 may generally be horizontally-stacked to a greater extent than the actuator arrangement of camera 100. The actuator arrangement of camera 100 may generally be vertically-stacked to a greater extent than the actuator arrangement of camera 130 in some embodiments.

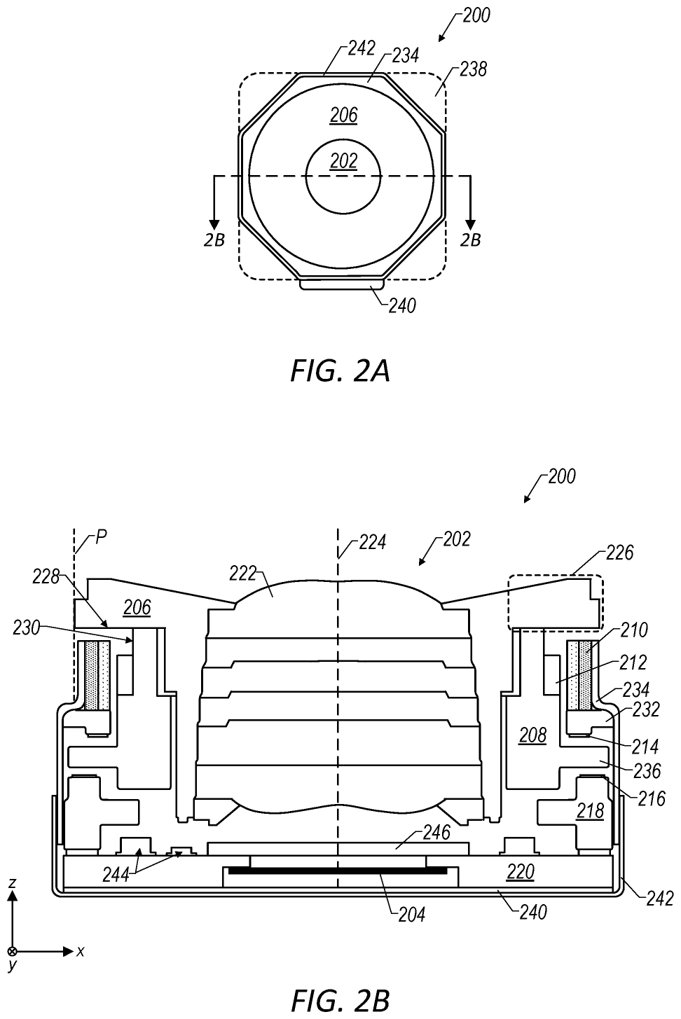

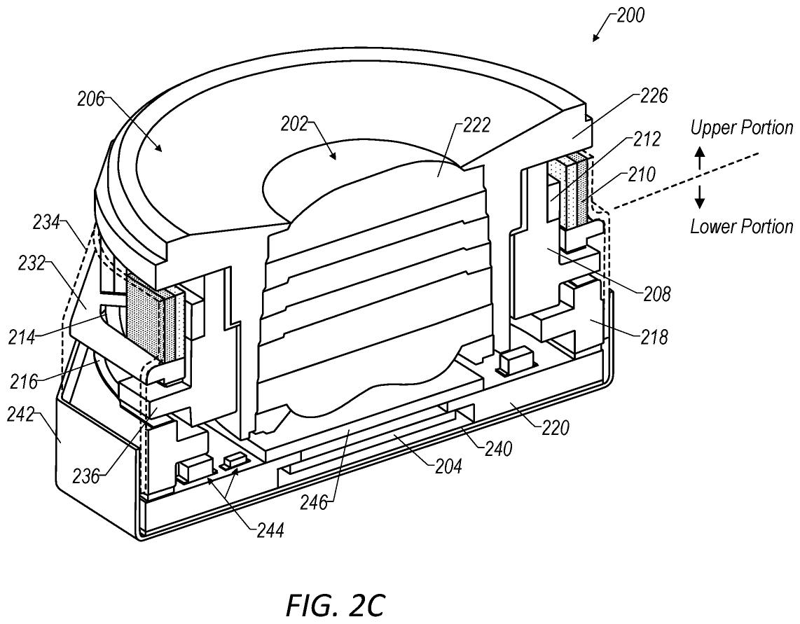

FIGS. 2A-2C illustrate views of an example camera 200 having an actuator arrangement that may enable a camera size reduction. FIG. 2A shows a top view of the camera 200. FIG. 2B shows a side cross-sectional view of the camera 200, where the cross-section is taken along cross-section line 2B-2B indicated in FIG. 2A. FIG. 2C shows a perspective cross-sectional view of the camera 200.

In some embodiments, the camera 200 may include a lens group 202, an image sensor 204, a lens barrel 206, a lens carrier 208, an actuator (e.g., comprising one or more magnets 210 and one or more coils 212), a suspension arrangement (e.g., comprising an upper spring 214 and/or a lower spring 216), a base structure 218, and/or a substrate 220. The lens group 202 may include one or more lens elements 222 that define an optical axis 224. The camera 200 may be an embodiment of the camera 100 shown in FIG. 1, with additional details and/or additional features described herein with reference to FIGS. 2A-2C. Unless otherwise specified herein, the lens group 202, the image sensor 204, the lens barrel 206, the lens carrier 208, the magnet(s) 210, the coil(s) 212, the upper spring 214, the lower spring 216, the base structure 218, and/or the substrate 220, respectively, may be the same as the lens group 102, the image sensor 104, the lens barrel 106, the lens carrier 108, the magnet(s) 110, the coil(s) 112, the upper spring 114, the lower spring 116, the base structure 118, and/or the substrate 120.

According to some embodiments, the lens barrel 206 may comprise a flange 226 at a top portion of the camera 200. An underside 228 of the flange 226 may extend, in a direction orthogonal to the optical axis 224 (e.g., the X-axis direction and/or the Y-axis direction) towards one or more sides of the camera 200. Furthermore, the lens carrier 208 may comprise an outer surface 230 that extends, in a direction parallel to the optical axis 224 (e.g., the Z-axis direction), from the underside 228 of the flange 226 towards a bottom of the camera 200.

In various embodiments, the actuator may comprise a voice coil motor (VCM) actuator. For example, the VCM actuator may include one or more magnet-coil groups. According to some examples, a magnet-coil group may include a magnet 210 attached to one or more stationary structures of the camera 200, and a coil 212 to electromagnetically interact with the magnet 210. In various embodiments, the coil 212 may be attached to the lens carrier 208. In some embodiments, the coil 212 may be attached to the outer surface 230 of the lens carrier 208. Additionally, or alternatively, the coil 212 may be at least partially embedded within the lens carrier 208 in some embodiments. According to various embodiments, the magnet-coil group may be contained within a cavity that is at least partially defined by the underside 228 of the flange 226 and the outer surface 230 of the lens carrier 208, e.g., as indicated in FIG. 2B. In some embodiments, the cavity may be defined by a periphery of the flange 226 and the outer surface 230 of the lens carrier 208. FIG. 2B indicates an example periphery P (dashed line labeled “P”) of the flange 226.

As previously mentioned, the magnet(s) 210 may be attached to one or more stationary structures. In some embodiments, the stationary structure(s) may include one or more mounting spacers 232 and/or a shield can 234. The shield can 234 may form at least a portion of the side(s) of the camera 200. In some embodiments, an outermost extent of the cavity (within which the magnet-coil group may be contained) may be defined by the periphery P and/or the shield can 234. The mounting spacer(s) 232 may be attached to the shield can 234. In some embodiments, the mounting spacer(s) 232 may be element(s) used for mounting the magnet(s) 210 and/or spring(s) of the suspension arrangement at certain positions. In some examples, the mounting spacer(s) 232 may be used provide relative positioning between the magnet(s) 210 and one or more other components (e.g., the shield can 234, the coil 212, and/or the flange 226, etc.). In some embodiments, the mounting spacer(s) 232 may have an upper surface that extends, in a direction orthogonal to the optical axis 224 (e.g., in the X-axis direction and/or in the Y-axis direction), from the shield can 234 towards the lens group 202. The magnet(s) 210 may be disposed on the upper surface of the mounting spacer(s) 232, and the magnet(s) 210 may be attached to the upper surface of the mounting spacer(s) 232 and/or to the shield can 234. As indicated in FIGS. 2B and 2C, the magnet(s) 210 and/or the mounting spacer(s) 232 may abut an inner surface of the shield can 234.

According to some embodiments, the magnet(s) 210 may be positioned proximate the underside 228 of the flange 226, such that the flange 226 is above the magnet(s) 210 without intervening components between the magnet(s) 210 and the flange 226 in the direction parallel to the optical axis 224 (e.g., the Z-axis direction). In some embodiments, the flange 226 may have an outermost extent, in the direction orthogonal to the optical axis 224, that is at a first distance (in the direction orthogonal to the optical axis) from the optical axis 224. Furthermore, the magnet(s) 210 may have an outermost surface that is at a second distance (in the direction orthogonal to the optical axis) from the optical axis 224. In various embodiments, the first distance may be greater than or equal to the second distance, e.g., such that a radial extension of the flange 226 fully covers the magnet(s) 210 from above.

In various embodiments, the suspension arrangement may suspend the lens carrier 208 from one or more stationary structures of the camera 200, and allows motion of the lens group 202 enabled by the actuator. The suspension arrangement may include one or more springs (e.g., leaf spring(s)) in some embodiments. According to some embodiments, the suspension arrangement may include the upper spring 214 and/or the lower spring 216. The spring(s) may extend, in a direction orthogonal to the optical axis 224 (e.g., the X-axis direction and/or the Y-axis direction), from the lens carrier 208 to the stationary structure(s). In some embodiments, the stationary structure(s) may include the mounting spacer(s) 232 and/or the base structure 218. For example, the upper spring 214 may be attached to the lens carrier 208 and a lower surface of the mounting spacer(s) 232 in some embodiments. Additionally, or alternatively, the lower spring 216 may be attached to the lens carrier 208 and an upper surface of the base structure 218 in some embodiments. In this example, the base structure 218 may be an element used for mounting a portion of the lower spring 216. Furthermore, the base structure 218 may provide relative positioning between the lower spring 216 and one or more other components (e.g., the lens carrier 208, the upper spring 214, and/or the shield can 234, etc.).

In various embodiments, one or more magnet-coil groups of the actuator may be positioned above the suspension arrangement. For example, a top surface of the suspension arrangement may be positioned, in a direction parallel to the optical axis 224 (e.g., the Z-axis direction) between a bottom surface of a magnet-coil group and the image sensor 204. As indicated in FIGS. 2B and 2C, each of the magnets 210 and the coil 212 is positioned above the upper spring 214. In this example, the top surface of the suspension arrangement is the uppermost surface of the upper spring 214, and the bottom surface of the magnet-coil group is the lowermost surface of the magnets 210.

In some embodiments, the center of mass of a movable optics package (e.g., comprising the lens group 202, the lens barrel 206, and the lens carrier 208) may be below the magnet(s) 210 and coil(s) 212 of the actuator. Additionally, or alternatively, the center of mass of the movable optics package may be above at least a portion of the suspension arrangement. For example, the center of mass of the movable optics package may be closer, in the direction parallel to the optical axis 224 (e.g., the Z-axis direction), to the image sensor 204 than the magnet-coil group(s) of the actuator, and the center of mass of the movable optics package may be further, in the direction parallel to the optical axis 224, from the image sensor 204 than at least a portion of the suspension arrangement. As such, the center of mass of the movable optics package may be below a bottom of the magnet-coil group(s) and above a bottom of the suspension arrangement.

In some embodiments, the camera 200 may have an upper portion and a lower portion, e.g., as indicated by the labels “Upper Portion” and “Lower Portion” in FIG. 2C. According to some embodiments, the Upper Portion may have a different cross-sectional area than the Lower Portion. The Upper Portion may generally have a non-rectangular and/or a non-polygonal cross section (e.g., a curved shape), whereas the Lower Portion may generally have a rectangular and/or a polygonal cross section.

In some embodiments, the Upper Portion may include at least a portion of a lens barrel arrangement. For example, the Upper Portion may include an upper portion of the lens barrel 206 and/or an upper portion of the lens carrier 208. Furthermore, the Upper Portion may include the magnet-coil group(s) of the actuator. According to some embodiments, the Upper Portion may include at least an upper portion of the shield can 234.

In some embodiments, the Lower Portion may include, for example, the image sensor 204 and the substrate 220. Furthermore, the Lower Portion may include a lower portion of the lens barrel arrangement in some embodiments. For example, the Lower Portion may include a lower portion of the lens barrel 206 and/or a lower portion of the lens carrier 208. In some embodiments, the Lower Portion may include at least a lower portion of the shield can 234. In various embodiments, the Lower Portion may include the base structure 218, the mounting spacer 232, the upper spring 214, and/or the lower spring 216. It should be understood that the components described herein as being part of the Upper Portion and the Lower Portion are intended as non-limiting examples. In various embodiments, the Upper Portion and/or the Lower Portion may include additional or fewer components than those specifically mentioned herein.

As indicated in FIG. 2B, the shield can 234 may form at least a portion of one or more sides of the camera 200. In some embodiments, the shield can 234 may extend, in the direction parallel to the optical axis 224 (e.g., the Z-axis direction), adjacent to an outer surface of the magnet(s) 210 (which may define a height dimension of the magnet(s) 210), so as to cover the outer surface of the magnet(s) 210 along at least the height dimension. In this manner, the shield can 234 may function as a Faraday cage that provides electromagnetic shielding to the camera 200, e.g., to reduce and/or avoid electromagnetic interference between the actuator of the camera 200 and one or more nearby external components (external to the camera 200), such as a nearby VCM actuator of another camera in a multi-camera system and/or non-camera modules (e.g., antennas). This may allow for the actuator to be driven with a pulse width modulation (PWM) scheme for power efficiency in some examples. Additionally, or alternatively, the shield can 234 may provide improved radio frequency (RF) shielding for the image sensor 204 and signal routing on the substrate 220, which may result in the image data with reduced noise.

In some embodiments, the lens carrier 208 may comprise a protrusion 236 that extends, in a direction orthogonal to the optical axis 224 (e.g., the X-axis direction and/or the Y-axis direction), towards the shield can 234, e.g., as indicated in FIGS. 2B and 2C. According to some embodiments, the protrusion 236 may be positioned, in a direction parallel to the optical axis 224 (e.g., the Z-axis direction), between the mounting spacer 232 and the base structure 218. An outer surface of the protrusion 236 may face the shield can 234, and may provide a horizontal end stop (e.g., against the shield can 234) with respect to motion in one or more directions orthogonal to the optical axis 224 in some embodiments. An upper surface of the protrusion 236 may face the mounting spacer 232. A lower surface of the protrusion 236 may face the base structure 218. In some embodiments, the upper surface and/or the lower surface of the protrusion 236 may provide a respective vertical end stop (e.g., against the mounting spacer 232 or the base structure 218) with respect to motion in a respective direction parallel to the optical axis 224.

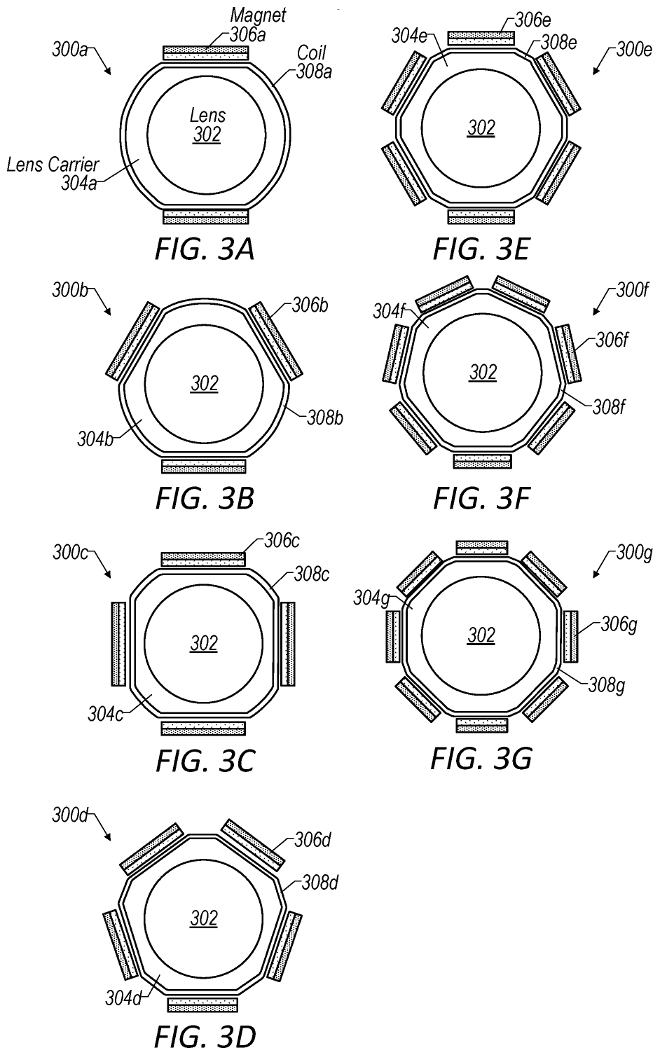

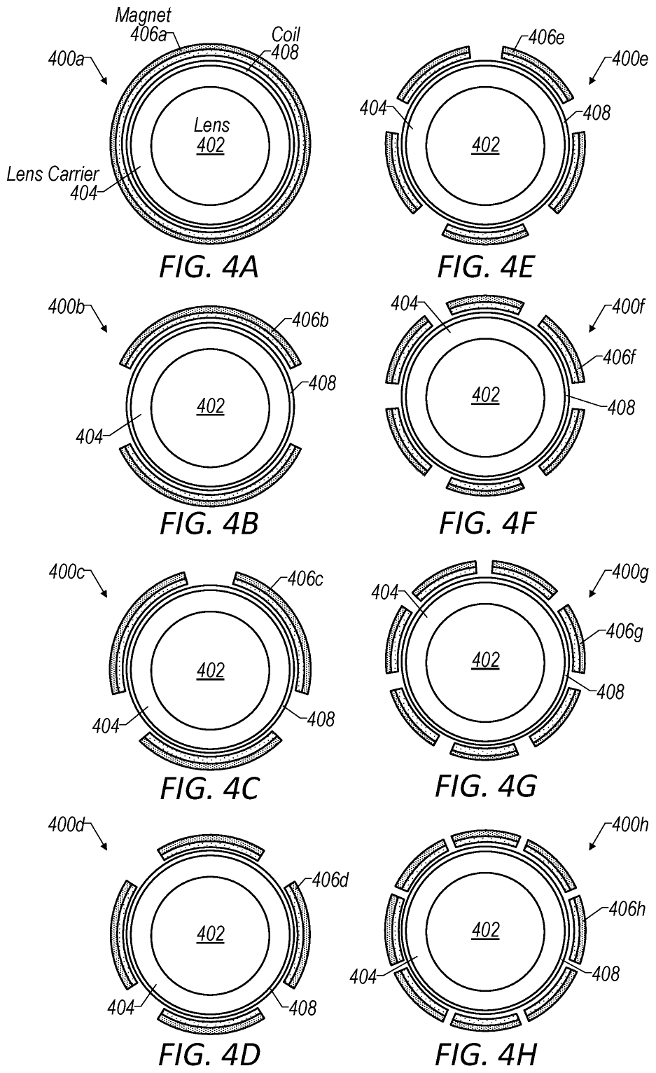

As further discussed herein with reference to FIGS. 3A-4H, the magnet(s) 210 may be arranged circumferentially around the lens carrier 210. As compared to some other cameras (e.g., camera 130 in FIG. 1) in which actuator magnets are arranged at corners of the camera module (e.g., in the corner areas 238 indicated by dashed lines in FIG. 2A), a tight circumferential arrangement of the magnet(s) 210 of the camera 200 may allow for a camera module having chamfered corners, e.g., via chamfering of the corner areas 238, as indicated in FIG. 2A. This chamfered corner configuration may result in a smaller camera footprint and/or may allow for space savings if the camera 200 is installed proximate one or more other cameras in a multi-camera system. In some embodiments, the chamfered corner configuration may additionally or alternatively provide space savings that enable the camera 200 to fit next to one or more non-camera modules, e.g., in a position (relative to one or more modules) that might not be feasible without such space savings.

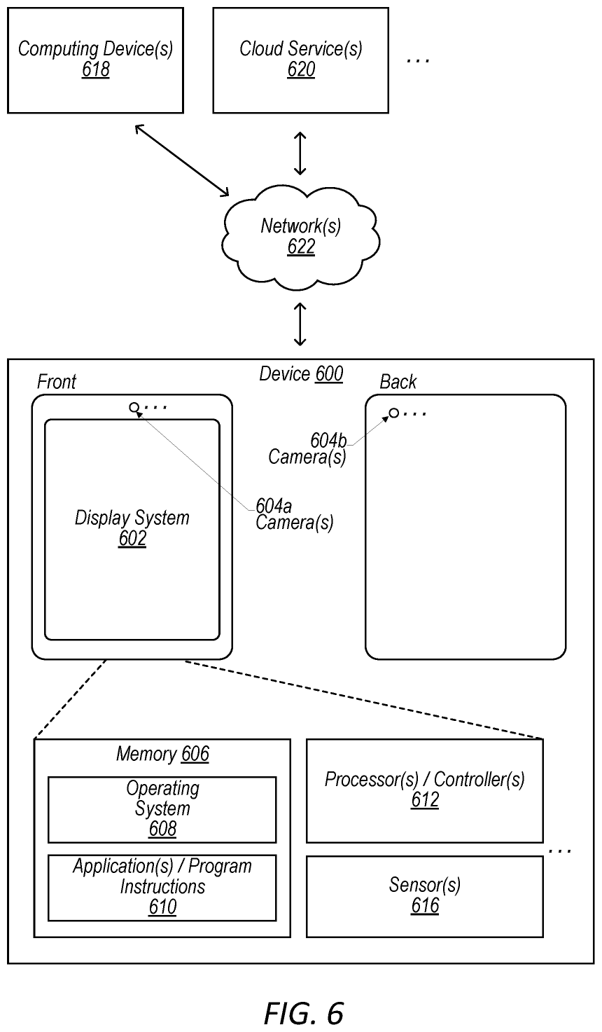

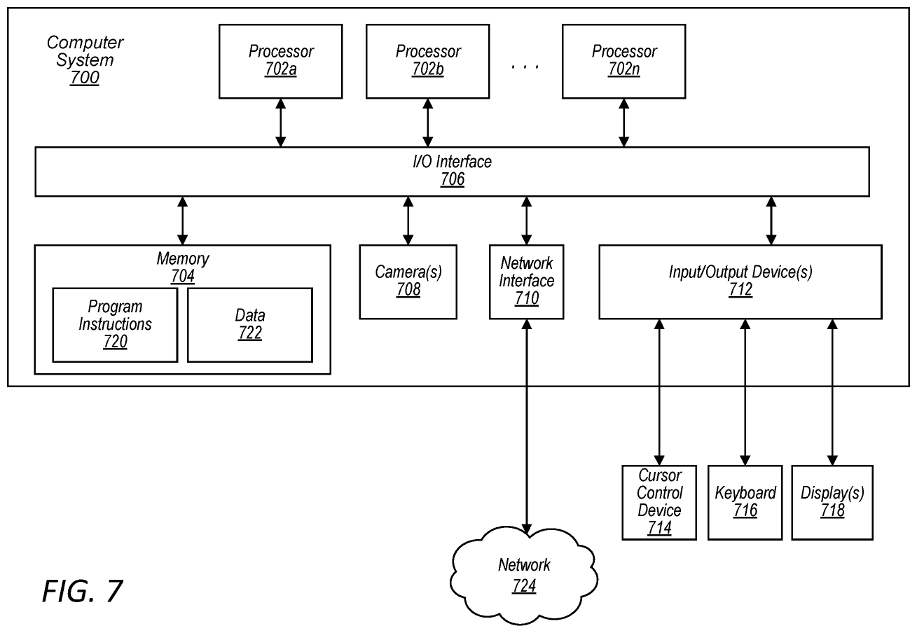

In various embodiments, the camera 200 may include a flex circuit 240 that may be configured to convey electrical signals (e.g., power and/or control signals). In some embodiments, the flex circuit 240 may be used to convey certain signals (e.g., signals associated with image data captured via the image sensor 204, signals associated with position sensor data captured via one or more position sensors, etc.) to one or more components that are external to the camera 200, such as an image signal processor (ISP) of a device (e.g., the device 600 in FIG. 6, the computer system 700 in FIG. 7, etc.). The flex circuit 240 may convey such signals to the image sensor 204 via the substrate 220 in some examples. In some embodiments, the camera 200 may include a stiffener 242 for providing structural support to the flex circuit 240 and/or to one or more other portions of the camera 200. The stiffener 242 may include a bottom wall disposed adjacent to a bottom surface of the flex circuit 240. In some embodiments, the stiffener 242 may also include one or more side walls (which also may be referred to as “tabs”) that are interconnected with the bottom wall of the stiffener 242. In some embodiments, the tab(s) of the stiffener 242 may be folded up from the bottom wall of the stiffener 242, e.g., to at least partially establish one or more sides of the camera 200. As indicated in FIGS. 2A-2C, in some embodiments a tab of the stiffener 242 may partially overlap with a corresponding side wall of the shield can 234, and the overlapping tab and side wall may form a side of the camera 200.

In some embodiments, one or more electrical components 240 may be coupled to the substrate 220. For example, the electrical component(s) 244 may be mounted on a top surface of the substrate 220, as indicated in FIGS. 2B and 2C. In some embodiments, the electrical component(s) 244 may include one or more driver integrated circuits, one or more position sensors, etc. According to some embodiments, the flex circuit 240 may be used to convey control signals (e.g., signals associated with actuator commands from controller(s) of a device's ISP to the driver integrated circuit(s) of the camera 200, e.g., via the substrate 220. Furthermore, the driver integrated circuit(s) may be used in providing drive current to the coil(s) 212, e.g., via the substrate 220, the base structure 218, the spring(s) of the suspension arrangement, and/or the lens carrier 208.

In some embodiments, the camera 200 may include one or more optical filters 246 coupled with the substrate 220 and positioned, in the direction parallel to the optical axis 224 (e.g., the Z-axis direction), between the lens group 202 and the image sensor 204. For example, the optical filter(s) 246 may include an infrared cut-off filter (IRCF) in some embodiments.

FIGS. 3A-3G each illustrates a respective schematic diagram of a respective example magnetic arrangement 300a-300g comprising bar magnets, for an actuator arrangement that may be used in a camera (e.g., camera 100 in FIG. 1, camera 200 in FIGS. 2A-2C, etc.) to enable a camera size reduction, in accordance with some embodiments. The schematic diagrams respectively show a lens 302 at least partially encircled by a respective lens carrier 304a-304g (and/or lens barrel), with respective bar magnet(s) 306a-306g and respective coil(s) 308a-308g being arranged circumferentially around the respective lens carrier 304a-304g. In various embodiments, the respective coil(s) 308a-308g may encircle an outer periphery of the respective lens carrier 304a-304g. Furthermore, in some embodiments, the magnet(s) 306a-306g may be distributed in a regular pattern that at least partially encircles the respective coil(s) 308a-308g.

FIG. 3A shows a magnetic arrangement 300a that includes a coil 308a attached to the lens carrier 304a, and two bar magnets 306a positioned proximate the coil 308a, e.g., opposite one another relative to the lens 302. FIG. 3B shows a magnetic arrangement 300b that includes a coil 308b and three bar magnets 306b. FIG. 3C shows a magnetic arrangement 300c that includes a coil 308c and four bar magnets 306c. FIG. 3D shows a magnetic arrangement 300d that includes a coil 308d and five bar magnets 306d. FIG. 3E shows a magnetic arrangement 300e that includes a coil 308e and six bar magnets 306e. FIG. 3F shows a magnetic arrangement 300f that includes a coil 308f and seven bar magnets 306f. FIG. 3G shows a magnetic arrangement 300g that includes a coil 308g and eight bar magnets 306g. As indicated in FIGS. 3A-3G, in various embodiments the respective coil 308a-308g may comprise flat portions that face the respective magnets 306a-306g, and may comprise rounded portions between the flat portions. It should be understood that the cameras described herein may have actuator arrangements that differ (e.g., with respect to number and/or shape of magnets and/or coils, etc.) from these example magnetic arrangements 300a-300g.

FIGS. 4A-4H each illustrates a respective schematic diagram of a respective example magnetic arrangement 400a-400h comprising one or more arced magnets, for an actuator arrangement that may be used in a camera (e.g., camera 100 in FIG. 1, camera 200 in FIGS. 2A-2C, etc.) to enable a camera size reduction, in accordance with some embodiments. The schematic diagrams respectively show a lens 402 at least partially encircled by a lens carrier 404 (and/or lens barrel), with respective arced magnet(s) 406a-406h and a coil 408 being arranged circumferentially around the lens carrier 404. In various embodiments, the coil 408 may encircle an outer periphery of the respective lens carrier 404. Furthermore, in some embodiments, the magnet(s) 406a-406h may be distributed in a regular pattern that at least partially encircles the coil 408.

FIG. 4A shows a magnetic arrangement 400a that includes the coil 408 attached to the lens carrier 404, and one arced magnet positioned proximate the coil 408, e.g., encircling the coil 408. FIG. 4B shows a magnetic arrangement 400b that includes the coil 408 and two arced magnets 406b, e.g., opposite each other relative to the lens 402. FIG. 4C shows a magnetic arrangement 400c that includes the coil 408 and three arced magnets 406c. FIG. 4D shows a magnetic arrangement 400d that includes the coil 408 and four arced magnets 406d. FIG. 4E shows a magnetic arrangement 400e that includes the coil 408 and five arced magnets 406e. FIG. 4F shows a magnetic arrangement 400f that includes the coil 408 and six arced magnets 406f. FIG. 4G shows a magnetic arrangement 400g that includes the coil 408 and seven arced magnets 406g. FIG. 4H shows a magnetic arrangement 400h that includes the coil 408 and eight arced magnets 406h. It should be understood that the cameras described herein may have actuator arrangements that differ (e.g., with respect to number and/or shape of magnets and/or coils, etc.) from these example magnetic arrangements 400a-400h.

FIGS. 5A and 5B each illustrates a respective schematic side view of a respective example system 500a and 500b that includes a camera 502 (having an actuator arrangement that may enable a camera size reduction, such as camera 100 in FIG. 1, camera 200 in FIGS. 2A-2C, etc.) mounted in a device 504 (e.g., device 600 in FIG. 6, computer system 700 in FIG. 7, etc.). In some embodiments, the device 504 may have an enclosure 506 (also referred to herein as an “outer cover”) that encases at least a portion of an interior space of the device 504. The enclosure 506 may define a turret 508 for receiving at least a portion of the camera 502. For example, the turret 508 may be formed at a side wall of the enclosure 506. The turret 508 may comprise a cover window having an inner surface and/or an outer surface at which a black mask 510 may be applied. The black mask 510 may define a region (“black mask opening”) configured to allow light to pass to the camera 502. For example, such a region may be an unmasked region aligned with an aperture of the camera 502. The black mask opening may have a diameter D. Furthermore, the camera 502 may have a field of view (FOV) indicated by FOV cone 512.

FIG. 5A shows an example profile 514a associated with a different camera (e.g., like the camera 130 in FIG. 1, but without a lens flange). As compared with profile 514a, the camera 502 may have a slimmer profile, e.g., due to a size reduction in the X-axis direction and/or the Y-axis direction, which may be enabled by the actuator arrangements described herein with reference to FIGS. 1-4H. Furthermore, profile 514a indicates that the associated camera does not include a lens flange near the cover window, so a user's line of sight 516 may allow the user to see internal components of such a camera, which may be undesirable from an industrial design and/or cosmetic point of view. By contrast, the camera 502 may include a flange (e.g., flange 132 in FIG. 1, flange 226 in FIG. 2, etc.) that can block the line of sight 516 such that the user is unable to see the internal components of the camera 502.

FIG. 5B shows another example profile 514b associated with another different camera (like the camera 130 in FIG. 1). Unlike profile 514a, profile 514b indicates that the associated camera includes a lens flange near the cover window. However, as compared with profile 514b, the camera 502 may have a slimmer profile, e.g., due to a size reduction in the X-axis direction and/or the Y-axis direction, which may be enabled by the actuator arrangements described herein with reference to FIGS. 1-4H. As discussed herein with reference to FIGS. 1-2C, and as indicated by the profile of camera 502, the magnet(s) and/or the coil(s) of the actuator arrangements disclosed herein may be tucked in under a flange of a lens barrel of the camera 502, e.g., within a space generally indicated by arrow 518 in FIG. 5B, which is unutilized (empty) in the different camera associated with profile 514b. The camera 502 may be mounted within the interior space of the device 504 such that the flange of the lens barrel, at least a portion of the magnet(s) of the actuator, and at least a portion of the coil(s) of the actuator, are disposed within the turret 508.

FIG. 6 illustrates a schematic representation of an example device 600 that may include a camera (e.g., camera 100 in FIG. 1, camera 200 in FIGS. 2A-2C, etc.) having an actuator arrangement that may enable a camera size reduction, in accordance with some embodiments. In some embodiments, the device 600 may be a mobile device and/or a multifunction device. In various embodiments, the device 600 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 600 may include a display system 602 (e.g., comprising a display and/or a touch-sensitive surface) and/or one or more cameras 604. In some non-limiting embodiments, the display system 602 and/or one or more front-facing cameras 604a may be provided at a front side of the device 600, e.g., as indicated in FIG. 6. Additionally, or alternatively, one or more rear-facing cameras 604b may be provided at a rear side of the device 600. In some embodiments comprising multiple cameras 604, some or all of the cameras may be the same as, or similar to, each other. Additionally, or alternatively, some or all of the cameras may be different from each other. In various embodiments, the location(s) and/or arrangement(s) of the camera(s) 604 may be different than those indicated in FIG. 6.

Among other things, the device 600 may include memory 606 (e.g., comprising an operating system 608 and/or application(s)/program instructions 610), one or more processors and/or controllers 612 (e.g., comprising CPU(s), memory controller(s), display controller(s), and/or camera controller(s), etc.), and/or one or more sensors 616 (e.g., orientation sensor(s), proximity sensor(s), and/or position sensor(s), etc.). In some embodiments, the device 600 may communicate with one or more other devices and/or services, such as computing device(s) 618, cloud service(s) 620, etc., via one or more networks 622. For example, the device 600 may include a network interface (e.g., network interface 710) that enables the device 600 to transmit data to, and receive data from, the network(s) 622. Additionally, or alternatively, the device 600 may be capable of communicating with other devices via wireless communication using any of a variety of communications standards, protocols, and/or technologies.

FIG. 7 illustrates a schematic block diagram of an example computing device, referred to as computer system 700, that may include or host embodiments of a camera having an actuator arrangement that may enable a camera size reduction, e.g., as described herein with reference to FIGS. 1-6. In addition, computer system 700 may implement methods for controlling operations of the camera and/or for performing image processing images captured with the camera. In some embodiments, the device 600 (described herein with reference to FIG. 6) may additionally, or alternatively, include some or all of the functional components of the computer system 700 described herein.

The computer system 700 may be configured to execute any or all of the embodiments described above. In different embodiments, computer system 700 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 700 includes one or more processors 702 coupled to a system memory 704 via an input/output (I/O) interface 706. Computer system 700 further includes one or more cameras 708 coupled to the I/O interface 706. Computer system 700 further includes a network interface 710 coupled to I/O interface 706, and one or more input/output devices 712, such as cursor control device 714, keyboard 716, and display(s) 718. In some cases, it is contemplated that embodiments may be implemented using a single instance of computer system 700, while in other embodiments multiple such systems, or multiple nodes making up computer system 700, may be configured to host different portions or instances of embodiments. For example, in one embodiment some elements may be implemented via one or more nodes of computer system 700 that are distinct from those nodes implementing other elements.

In various embodiments, computer system 700 may be a uniprocessor system including one processor 702, or a multiprocessor system including several processors 702 (e.g., two, four, eight, or another suitable number). Processors 702 may be any suitable processor capable of executing instructions. For example, in various embodiments processors 702 may be general-purpose or embedded processors implementing any of a variety of instruction set architectures (ISAs), such as the x86, PowerPC, SPARC, or MIPS ISAs, or any other suitable ISA. In multiprocessor systems, each of processors 702 may commonly, but not necessarily, implement the same ISA.

System memory 704 may be configured to store program instructions 720 accessible by processor 702. In various embodiments, system memory 704 may be implemented using any suitable memory technology, such as static random access memory (SRAM), synchronous dynamic RAM (SDRAM), nonvolatile/Flash-type memory, or any other type of memory. Additionally, existing camera control data 722 of memory 704 may include any of the information or data structures described above. In some embodiments, program instructions 720 and/or data 722 may be received, sent or stored upon different types of computer-accessible media or on similar media separate from system memory 704 or computer system 700. In various embodiments, some or all of the functionality described herein may be implemented via such a computer system 700.

In one embodiment, I/O interface 706 may be configured to coordinate I/O traffic between processor 702, system memory 704, and any peripheral devices in the device, including network interface 710 or other peripheral interfaces, such as input/output devices 712. In some embodiments, I/O interface 706 may perform any necessary protocol, timing or other data transformations to convert data signals from one component (e.g., system memory 704) into a format suitable for use by another component (e.g., processor 702). In some embodiments, I/O interface 706 may include support for devices attached through various types of peripheral buses, such as a variant of the Peripheral Component Interconnect (PCI) bus standard or the Universal Serial Bus (USB) standard, for example. In some embodiments, the function of I/O interface 706 may be split into two or more separate components, such as a north bridge and a south bridge, for example. Also, in some embodiments some or all of the functionality of I/O interface 706, such as an interface to system memory 704, may be incorporated directly into processor 702.

Network interface 710 may be configured to allow data to be exchanged between computer system 700 and other devices attached to a network 724 (e.g., carrier or agent devices) or between nodes of computer system 700. Network 724 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 710 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 712 may, in some embodiments, include one or more display terminals, keyboards, keypads, touchpads, scanning devices, voice or optical recognition devices, or any other devices suitable for entering or accessing data by one or more computer systems 700. Multiple input/output devices 712 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 710.

Those skilled in the art will appreciate that computer system 700 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A camera, comprising:
a lens group comprising one or more lens elements that define an optical axis;
an image sensor to capture image data based on light that passes through the lens group;
a lens barrel arrangement within which at least a portion of the lens group is contained such that the lens group is movable together with the lens barrel arrangement, wherein the lens barrel arrangement comprises:
a flange at a top portion of the camera, and wherein an underside of the flange extends, in a first direction orthogonal to the optical axis, towards one or more sides of the camera; and
an outer surface that extends, in a second direction parallel to the optical axis, from the underside of the flange towards a bottom of the camera; and
a voice coil motor (VCM) actuator to move the lens group relative to the image sensor, the VCM actuator comprising:
a magnet-coil group, comprising:
a magnet attached to a stationary structure of the camera; and
a coil to electromagnetically interact with the magnet, wherein the coil is attached to the lens barrel arrangement;
wherein the magnet-coil group is contained within a cavity that is defined by a periphery of the flange and the outer surface of the lens barrel arrangement.

2. The camera of claim 1, wherein:
the flange comprises an outermost extent, in the first direction orthogonal to the optical axis and away from the lens group, that is at a first distance, in the first direction, from the optical axis;
the magnet comprises an outermost surface that is at a second distance, in the first direction, from the optical axis; and
the first distance is greater than or equal to the second distance.

3. The camera of claim 1, wherein the magnet is positioned proximate the underside of the flange, such that the flange is above the magnet without intervening components between the magnet and the flange in the second direction parallel to the optical axis.

4. The camera of claim 1, further comprising:
a suspension arrangement comprising one or more springs that extend, in the first direction orthogonal to the optical axis, from the lens barrel arrangement to one or more stationary structures of the camera, so as to suspend the lens barrel arrangement from the one or more stationary structures;
wherein the magnet-coil group is positioned above the suspension arrangement, such that a top surface of the suspension arrangement is positioned, in the second direction parallel to the optical axis, between a bottom surface of the magnet-coil group and the image sensor.

5. The camera of claim 1, further comprising:
a suspension arrangement comprising one or more springs that extend, in the first direction orthogonal to the optical axis, from the lens barrel arrangement to one or more stationary structures of the camera, so as to suspend the lens barrel arrangement from the one or more stationary structures;
wherein the lens group and the lens barrel arrangement are a movable optics package that has a center of mass that is (i) closer, in the second direction parallel to the optical axis, to the image sensor than the magnet-coil group, and (ii) further, in the second direction, from the image sensor than at least a portion of the suspension arrangement, such that the center of mass is below a bottom of the magnet-coil group and above a bottom of the suspension arrangement.

6. The camera of claim 1, further comprising:
a shield can that forms at least a portion of the one or more sides of the camera;
a mounting spacer configured to hold the magnet in a fixed position relative to the shield can;
a suspension arrangement, comprising:
an upper spring that is attached to the lens barrel arrangement and a lower surface of the mounting spacer; and
a lower spring that is attached to the lens barrel arrangement and an upper surface of the base structure.

7. The camera of claim 1, wherein:
the coil encircles an outer periphery of the lens barrel arrangement;
the VCM actuator further comprises:
one or more additional magnets, wherein a plurality of magnets comprising the magnet and the one or more additional magnets is distributed in a regular pattern that at least partially encircles the coil; and
the VCM actuator is configured to move the lens group in at least the second direction parallel to the optical axis, relative to the image sensor, to provide focus movement of an image on the image sensor.

8. A system, comprising:
one or more processors;
memory storing program instructions executable by the one or more processors to control operations of a camera; and
the camera, comprising:
a lens group comprising one or more lens elements that define an optical axis;
an image sensor to capture image data based on light that passes through the lens group;
a lens barrel arrangement fixedly coupled with the lens group, such that the lens group is movable together with the lens barrel arrangement;
a suspension arrangement for suspending the lens barrel arrangement from one or more stationary structures of the camera, wherein the suspension arrangement comprises an uppermost spring that is closest, among a total set of one or more suspension springs in the camera, to a top of the camera, and wherein the uppermost spring extends, in a first direction orthogonal to the optical axis, from the lens carrier to the one or more stationary structures;
a voice coil motor (VCM) actuator to move the lens group relative to the image sensor, the VCM actuator comprising:
a magnet-coil group, comprising:
a magnet attached to a stationary structure of the one or more stationary structures; and
a coil to electromagnetically interact with the magnet, wherein the coil is fixedly coupled with the lens barrel arrangement;
wherein the magnet-coil group is positioned above the suspension arrangement, such that the uppermost spring is positioned, in a second direction parallel to the optical axis, between a bottom surface of the magnet-coil group and the image sensor.

9. The system of claim 8, wherein the lens barrel arrangement comprises:
a flange at a top portion of the camera, wherein an underside of the flange extends, in a first direction orthogonal to the optical axis, towards one or more sides of the camera; and
an outer surface that extends, in the second direction parallel to the optical axis, from the underside of the flange towards a bottom of the camera;
wherein:
the coil is attached to the lens barrel arrangement; and
the magnet-coil group is contained within a cavity that is at least partially defined by the underside of the flange, the outer surface of the lens barrel arrangement, and the stationary structure to which the magnet is attached.

10. The system of claim 8, wherein the lens group and the lens barrel arrangement are a movable optics package that has a center of mass that is (i) closer, in the second direction parallel to the optical axis, to the image sensor than the magnet-coil group, and (ii) further, in the second direction, from the image sensor than at least a portion of the suspension arrangement, such that the center of mass is below a bottom of the magnet-coil group and above a bottom of the suspension arrangement.

11. The system of claim 8, wherein the camera further comprises:
a shield can that forms at least a portion of one or more sides of the camera, wherein the shield can extends, in the second direction parallel to the optical axis, adjacent to an outer surface of the magnet that defines a height dimension of the magnet in the second direction, so as to cover the outer surface of the magnet along at least the height dimension; and
a mounting spacer configured to hold the magnet in a fixed position relative to the shield can.

12. The system of claim 11, wherein the one or more springs of the suspension arrangement comprise:
an upper spring that is attached to the lens barrel arrangement and to a lower surface of the mounting spacer, wherein the lower surface and the upper surface face in opposite directions; and
a lower spring that is attached to the lens barrel arrangement and to an upper surface of the base structure.

13. The system of claim 11, wherein:
the lens barrel arrangement comprises a protrusion that extends, in the first direction orthogonal to the optical axis, towards the shield can;
the protrusion is positioned, in the second direction parallel to the optical axis, between the mounting spacer and a base structure of the camera; and
an outer surface of the protrusion faces the shield can and provides a horizontal end stop with respect to motion in one or more directions orthogonal to the optical axis.

14. The system of claim 13, wherein:
an upper surface of the protrusion faces the mounting spacer;
a lower surface of the protrusion faces the base structure; and
at least one of the upper surface or the lower surfaces provides a respective vertical end stop with respect to motion in a respective direction parallel to the optical axis.

15. The system of claim 8, wherein:
the coil encircles an outer periphery of the lens barrel arrangement;
the VCM actuator further comprises:
one or more additional magnets, wherein a plurality of magnets comprising the magnet and the one or more additional magnets is distributed in a regular pattern that at least partially encircles the coil; and
the VCM actuator is configured to move the lens group in at least the second direction parallel to the optical axis, relative to the image sensor, to provide autofocus movement of an image on the image sensor.

16. The system of claim 15, wherein the plurality of magnets comprises:
bar magnets; or
arced magnets.

17. A device, comprising:
one or more processors;
memory storing program instructions executable by the one or more processors to control operations of a camera; and
an outer cover that encases at least a portion of an interior space of the device, wherein the outer cover defines a camera turret for receiving at least a portion of the camera within the interior space; and
the camera, comprising:
a lens group comprising one or more lens elements that define an optical axis;
an image sensor to capture image data based on light that passes through the lens group;
a lens barrel arrangement within which at least a portion of the lens group is contained such that the lens group is movable together with the lens barrel arrangement, wherein the lens barrel comprises:
a flange at a top portion of the camera, and wherein the flange extends, in a first direction orthogonal to the optical axis, towards one or more sides of the camera; and
a voice coil motor (VCM) actuator to move the lens group relative to the image sensor, in at least a direction parallel to the optical axis, wherein the VCM actuator comprises:
a magnet attached to a stationary structure of the camera; and
a coil to electromagnetically interact with the magnet, wherein the coil is fixedly coupled with the lens barrel arrangement;
wherein the camera is mounted within the interior space of the device such that the flange of the lens barrel arrangement, at least a portion of the magnet, and at least a portion of the coil are disposed within the camera turret.

18. The device of claim 17, further comprising:
a suspension arrangement that suspends the lens barrel arrangement from one or more stationary structures of the camera and that allows motion of the lens group enabled by the VCM actuator;
wherein the lens group and the lens barrel arrangement are a movable optics package that has a center of mass that is (i) closer, in the second direction parallel to the optical axis, to the image sensor than the magnet-coil group, and (ii) further, in the second direction, from the image sensor than at least a portion of the suspension arrangement, such that the center of mass is below a bottom of the magnet-coil group and above a bottom of the suspension arrangement.

19. The device of claim 18, wherein the camera further comprises:
a shield can that forms at least a portion of one or more sides of the camera, wherein the shield can extends, in the second direction parallel to the optical axis, adjacent to an outer surface of the magnet that defines a height dimension of the magnet in the second direction, so as to cover the outer surface of the magnet along at least the height dimension;
a base structure mounted on a substrate and positioned proximate the shield can, wherein the image sensor is attached to the substrate; and
a mounting spacer configured to hold the magnet in a fixed position relative to the shield can.

20. The device of claim 19, wherein the one or more springs of the suspension arrangement comprise:
an upper spring that is attached to the lens barrel arrangement and to a lower surface of the mounting spacer; and
a lower spring that is attached to the lens barrel arrangement and to an upper surface of the base structure;
wherein the mounting spacer is configured to hold the magnet above the upper spring and lower spring.
